(19) United States
(12) Patent Application Publication
(10) Pub. No.: US 2003/0013339 A1
(43) Pub. Date: Jan. 16, 2003

(54) Connecting structure of a pipe-type lamp

(76) Inventor: Wen-Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/904,525

(22) Filed: Jul. 16, 2001

(51) Int. Cl. H01R 4/24

(52) U.S. Cl. 439/427

(57) ABSTRACT

The present invention relates to a connecting structure of a pipe-type lamp, which includes a joint and a tube body. The joint is provided with a multi-step cone-end for inserting into the tube body to assemble a long pipe-type lamp and the multi-step cone-end of the joint can increase connecting strength between the joint and the tube body and prevents from separation therebetween.

### BACKGROUND OF THE INVENTION

As shown in FIG. 1, a conventional pipe-type lamp includes a tube body (2) with several bulbs (21) therein. Both ends of the tube body (2) are provided with a pair of joints (1) in order to connect with another tube body (2) for forming a long pipe-type lamp and obtaining electrical connection. The prior joint (1) includes a cone-end (11) for inserting into the tube body (2) in ease. But the connection will be not enough because of smooth surface of the cone-end (11) and will be very possible to be loosened or released in use. Thus the long pipe-type lamp doesn't work.

Accordingly, the primary object of the invention is to provide a connecting structure of a pipe-type lamp, which includes an improved connecting joint having a multi-step cone-end for a better connection between the joint and the tube body to prevent from separation. Now the features and advantages of the present invention will be described in detail with reference to the accompanying drawings.

### BRIEF DESCRIPTION OF ACCOMPANYING DRAWINGS

FIG. 1 is a cross-sectional plan view showing a prior pipe-type lamp.

FIG. 2 is a cross-sectional plan view showing a pipe-type lamp according to the present invention.

FIG. 3 is a perspective view showing a pipe-type lamp according to the present invention.

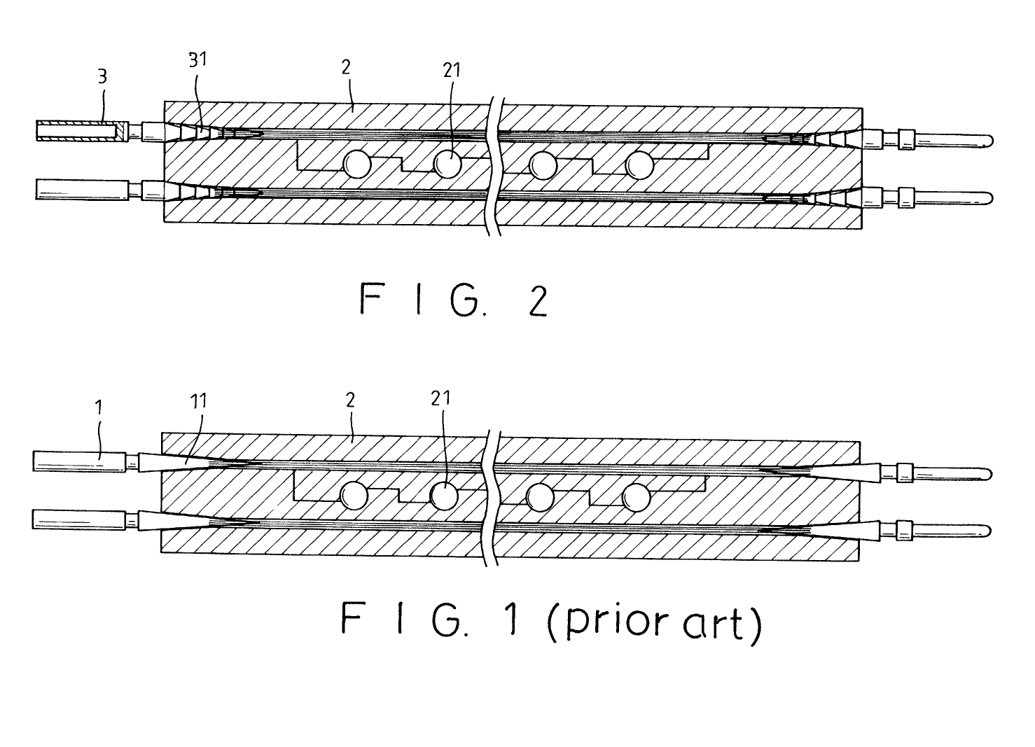

### DETAILED DESCRIPTION OF PREFERRED EMBODIMENTS

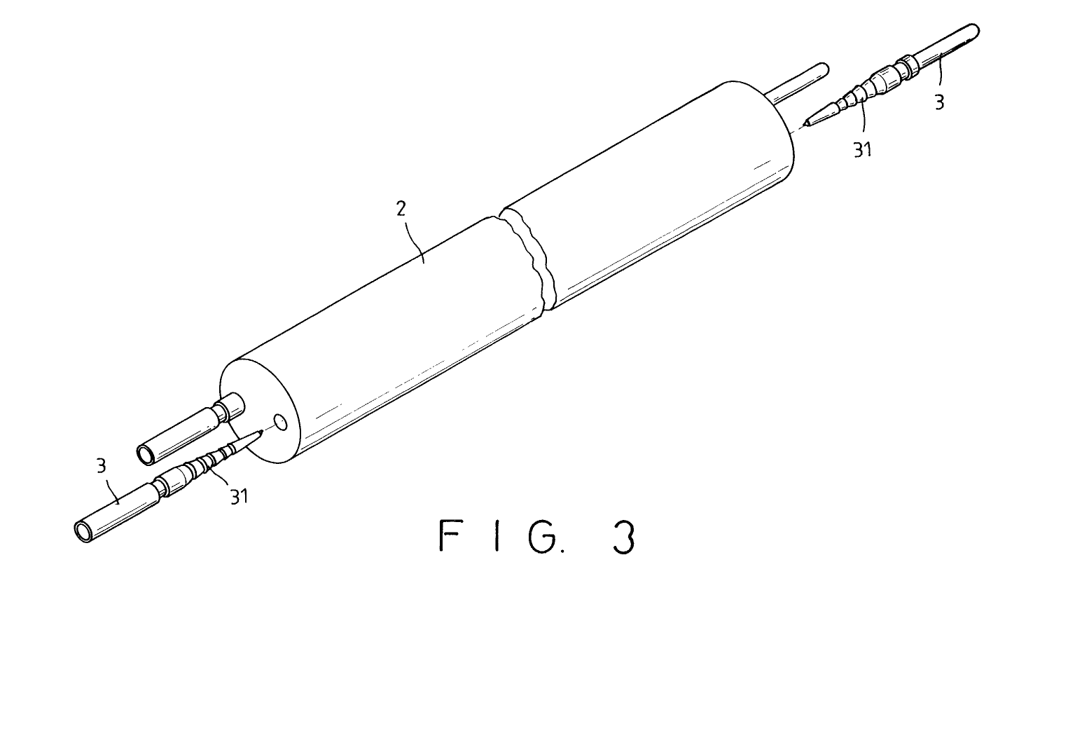

Please refer to FIGS. 2 and 3, the present invention relates to an improvement of a joint (3) of a pipe-type lamp. The joint (3) of this invention is provided with a multi-step cone-end (31) for inserting into a tube body (2) of the lamp. By use of the multi-step cone-end (31) for connecting, it can be found that a better assembling strength will be obtained because of every flange of every step on the multi-step cone-end (31). So the joint (3) and the tube body (2) can be connected together in secure and will never be loosened or released accidentally. The present invention obviously overcomes the drawback of a prior one.

Accordingly, the present invention provides an invented design of a multi-step cone-end that increases connecting stability between the joint and the tube body and prevents from separation therebetween. It obviously gains the utility and novelty for patent and is thus applied.

What is claimed is:

1. A connecting structure of a pipe-type lamp including a joint having been provided with a multi-step cone-end for inserting into a tube body to assemble a long pipe-type lamp, wherein the multi-step cone-end increases connecting strength between the joint and the tube body and prevents from separation therebetween.
